(19) United States
(12) Patent Application Publication
(10) Pub. No.: US 2015/0224750 A1
(43) Pub. Date: Aug. 13, 2015

(54) SOUND-DEADENING MULTILAYER POLYMERIC STRUCTURES

(71) Applicant: E I DU PONT DE NEMOURS AND COMPANY, Wilmington, DE (US)

(72) Inventors: DONNA LYNN VISIOLI, LOWER GWYNEDD, PA (US); GEON-SEOK KIM, WILMINGTON, DE (US)

(21) Appl. No.: 14/618,622

(22) Filed: Feb. 10, 2015

Related U.S. Application Data
(60) Provisional application No. 61/938,183, filed on Feb. 11, 2014.

(51) Int. Cl. B32B 27/08; B32B 37/18; B32B 7/12; B32B 7/02; B32B 27/34; B32B 27/30

(52) U.S. Cl. CPC B32B 27/08; B32B 27/34; B32B 27/306; B32B 27/308; B32B 7/12; B32B 7/02; B32B 37/18; B32B 2307/102; B32B 2307/546; B32B 2605/003

(57) ABSTRACT

Disclosed is a multilayer polymeric structure comprising a plurality of layers comprising at least one layer comprising a stiff polymeric material having a flexural modulus of about 140 kpsi to about 500 kpsi; and at least one layer comprising a soft polymeric material having a flexural modulus of less than 75 kpsi; wherein layers of the stiff polymeric material alternate with layers of the soft polymeric material; and the total thickness of the multilayer polymeric structure is from about 1 mm to about 14 mm. The structure provides improved sound-deadening properties.

### CROSS REFERENCE TO RELATED APPLICATION

This application claims priority under 35 U.S.C. §119(e) from U.S. Provisional Patent Application No. 61/938,183, filed Feb. 11, 2014, hereby incorporated herein by reference in its entirety.

### FIELD OF THE INVENTION

This invention relates to multilayer polymeric structures that have improved acoustic barrier properties and their use in making sound-deadening sheets and automotive carpet backing.

### BACKGROUND OF THE INVENTION

It is a goal in the automotive industry to reduce and minimize the amount of noise produced by the automobile, particularly noise inside the passenger compartment.

In general, there are three ways in which sound can be minimized or managed. The sound waves can be blocked, the vibrations can be damped, or the noise can be absorbed. To manage sound in these different ways, articles with different characteristics are required.

Certain ethylene copolymers combined with inorganic fillers and modified with, for example, organic acids have been used for sound management purposes such as sound barriers or sound deadening.

U.S. Pat. No. 4,434,258 discloses filled thermoplastic compositions obtained by blending about 0 to 50% by weight of an ethylene interpolymer, such as (among others) ethylene/vinyl esters; 0 to 20% by weight of a plasticizer selected from the group consisting of processing oils, epoxidized oils, polyesters, polyethers, polyether esters and combinations thereof; about 40 to 90% by weight of filler; from about 0.05 to about 5.0% by weight of at least one organic acid or acid derivative selected from the group consisting of saturated polycarboxylic acids having from 6 to 54 carbon atoms, unsaturated mono- and dicarboxylic acids having from 12 to 20 carbon atoms, alicyclic and aromatic carboxylic acids, and mono-, di- and trivalent metal salts, esters and amides of said acids.

U.S. Pat. No. 4,430,468 discloses similar filled thermoplastic compositions obtained by blending about 0 to 50% by weight of an ethylene interpolymer, such as (among others) ethylene/vinyl esters; 0 to 20% by weight of a plasticizer selected from the group consisting of processing oils, epoxidized oils, polyesters, polyethers, polyether esters and combinations thereof; about 40-90% by weight of filler; from about 0.05 to about 5.0% by weight of at least one surface active agent such as sulfonates, sulfates, phosphates, and optionally modifying resins, such as tackifiers and certain ethylene and propylene homo- and copolymers.

U.S. Pat. No. 6,319,969 discloses compositions of ethylene and/or α-olefin/vinyl or vinylidene interpolymers, particularly ethylene/styrene interpolymers, an organic acid and filler.

U.S. Pat. No. 7,696,277 discloses a highly-filled thermoplastic composition comprising a linear low density polyethylene and an ethylene vinyl acetate copolymer.

These patents also describe the above compositions in the form of sound-deadening sheets and carpets having a backside coating of the above compositions.

It is also known to use constrained layer damping structures and materials to reduce the vibration of the automobile body panels and thereby reduce the noise produced by the automobile. See U.S. Pat. Nos. 5,635,562; 4,987,194; and 5,143,755. For a given mass, increased stiffness shifts the natural vibrational frequency of a panel to a higher frequency which is more easily damped by a constrained layer structure.

U.S. Pat. No. 7,799,840 discloses a constrained layer damping structure, including a panel to be damped, a constraining layer and a layer of foam vibration damping material sandwiched therebetween. For example, the foam vibration damping material is a composition including 5-50 weight % polyvinyl butyral, 2-20 weight % plasticizer, 25-65 weight % filler, 1-15 weight % tackifier, and 0.1-8 weight % blowing agent, wherein the composition includes 15-65 weight % total thermoplastic inclusive of polyvinyl butyral.

U.S. Pat. No. 7,296,977 discloses a laminate material for damping a vibrational mode of a structure, the laminate material comprising a viscoelastic layer and a stiff constrained layer adhered to the viscoelastic layer, wherein the viscoelastic layer is elastomer-based and the constrained layer is made of steel, galvanized steel or aluminum.

U.S. Pat. No. 8,377,553 discloses a constrained layer damper featuring a constraining layer, a carrier layer, a release liner, a viscoelastic layer interposed between the constraining layer and a first surface of the carrier layer, and a silicone pressure-sensitive adhesive interposed between the release liner and a second surface of the carrier layer. The silicone pressure-sensitive adhesive has sufficient tackiness at room temperature to adhere the constrained layer damper, with the release liner removed, to a substrate.

Recent trends in the automotive industry have made it desirable to reduce vehicle weight for improved fuel economy, or reduce material thickness for design flexibility. Automobile manufacturers are seeking ways to lightweight all parts of a vehicle. Therefore it is desirable to replace the highly filled compositions previously used for sound-deadening applications with less dense materials having the same or improved sound-deadening performance.

### SUMMARY OF THE INVENTION

In one aspect, the invention provides a multilayer polymeric structure comprising a plurality of layers comprising

(a) at least one layer comprising a stiff polymeric material having a flexural modulus of greater than about 140 kpsi (965 MPa), such as from about 140 kpsi (965 MPa) to about 500 kpsi (3450 MPa), preferably from about 260 kpsi (1800 MPa) to about 500 kpsi (3450 MPa), and more preferably from about 300 kpsi (2070 MPa) to about 500 kpsi (3450 MPa); and

(b) at least one layer comprising a soft polymeric material having a flexural modulus of less than 75 kpsi, such as from about 3 kpsi to about 60 kpsi, preferably from about 3 kpsi to about 30 kpsi;

wherein layers of the stiff polymeric material alternate with layers of the soft polymeric material; and the total thickness of the multilayer polymeric laminate is from about 1.0 mm to about 14 mm.

In one embodiment, the structure comprises one layer comprising the stiff polymeric material and one layer comprising the soft polymeric material. This structure may further comprise an adhesive layer adjacent to the layer comprising the soft polymeric material that can be used to adhere the structure to a substrate.

In another embodiment, at least three layers of polymeric materials are combined such that two outer layers are on either side of an inner layer, wherein

(a) each of the two outer layers of polymeric materials independently comprises a stiff polymeric material having a flexural modulus of from about 140 kpsi (965 MPa) to about 500 kpsi (3450 MPa), preferably from about 260 kpsi (1800 MPa) to about 500 kpsi (3450 MPa), and more preferably from about 300 kpsi (2070 MPa) to about 500 kpsi (3450 MPa); and a thickness of about 0.2 to about 1.8 mm;

(b) the inner layer of polymeric material comprises a soft polymeric material having a flexural modulus of less than about 75 kpsi (517 MPa), such as from about 3 kpsi (20 MPa) to about 60 kpsi (414 MPa), preferably from about 3 kpsi to about 30 kpsi (207 MPa), and a thickness of about 0.2 to about 2 mm.

This structure may further comprise an adhesive layer adjacent to one of the layers comprising the stiff polymeric material that can be used to adhere the structure to a substrate.

In an alternate embodiment, at least three layers of polymeric materials are laminated such that two outer layers are on either side of an inner layer, wherein

(a) each of the two outer layers of polymeric materials independently comprises a soft polymeric material having a flexural modulus of less than 75 kpsi, such as from about 3 kpsi to about 60 kpsi, preferably from about 3 kpsi to about 30 kpsi, and a thickness of about 0.3 to about 1.8 mm; and

(b) the inner layer of polymeric material comprising a stiff polymeric material having has a flexural modulus of about 140 kpsi to about 500 kpsi, such as from about 140 kpsi to about 300 kpsi, or from about 300 to about 500 kpsi; and a thickness of about 0.1 to about 1.9 mm.

The multilayer laminates of this invention provide improved acoustic barrier properties with lighter weight while keeping the thickness constrained.

The invention also provides an article comprising the multilayer structure described above combined with a substrate, such as a carpet, textile or panel.

The invention also provides a method for providing sound deadening to a substrate comprising

(1) preparing a multilayer structure as described above; and

(2) combining the multilayer structure with the substrate.

The substrate may comprise carpet, foam, fabric or scrim material. The substrate may comprise a sheet or panel of polymeric material or composite with a high flexural modulus. The substrate may also comprise a panel comprising metal such as steel, galvanized steel or aluminum, or particle board. For example, the panel may be an automotive door panel, trunk panel, hood panel or floor panel.

### DETAILED DESCRIPTION OF THE INVENTION

All publications, patent applications, patents, and other references mentioned herein are incorporated by reference in their entirety. Unless otherwise defined, all technical and scientific terms used herein have the same meaning as commonly understood by one of ordinary skill in the art to which this invention belongs. In case of conflict, the present specification, including definitions, will control.

Unless stated otherwise, all percentages, parts, ratios, etc., are by weight. When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. When the term “about” is used in describing a value or an end-point of a range, the disclosure should be understood to include the specific value or end-point referred to.

Use of “a” or “an” are employed to describe elements and components of the invention. This is done merely for convenience and to give a general sense of the invention. This description should be read to include one or at least one and the singular also includes the plural unless it is obvious that it is meant otherwise.

In describing certain polymers it should be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts should be interpreted to mean that the polymer is made from those monomers or that amount of the monomers, and the corresponding polymers and compositions thereof.

The materials, methods, and examples herein are illustrative only and, except as specifically stated, are not intended to be limiting.

All reference to flexural modulus is to measurements in accordance with ASTM D790 at 25° C.

The difference between a film and a sheet is the thickness, but there is no set industry standard as to when a film becomes a sheet. Herein, a “film” refers to a thickness of about 20 mils (0.5 mm) or less, and a “sheet” refers to a thickness of greater than about 20 mils (0.5 mm).

As used herein the term “adhesive layer” refers to a layer that is on the surface of the multilayer structure used to adhere the multilayer structure to a substrate and the term “tie layer” refers to an interior layer of the multilayer structure used to adhere two layers of the multilayer structure together.

The multilayer polymeric structure used as a sound deadening material comprises a plurality of layers prepared such that layers comprising or consisting essentially of stiff polymeric materials alternate with layers comprising or consisting essentially of soft polymeric materials.

Sound deadening can be assessed by transmission loss or sound power loss measured in decibels. Sound deadening may also be characterized by reducing the amplitude of certain frequencies such as high frequency sound waves so that the sound is perceived to be less harsh to human hearing.

Insertion Loss (IL) is the sound pressure level difference at a point, usually outside the system without and with the attenuator present. It depends not only on the attenuator itself but also on the source impedance and the radiation impedance. Insertion loss is seen to be determined primarily by mass per unit area and is largely independent of damping and stiffness. It increases with frequency at 6 dB per octave and 6 dB per doubling of mass according to the normal incidence mass law, where m is mass per unit area and f is frequency:

IL≈20 log₁₀(mf)

The theoretical or expected insertion loss at a given frequency for a partition can be calculated according to the normal incidence mass law for a structure based on its mass per unit area. Additional benefits due to damping and/or other factors could further reduce the sound transmittance. The difference between the expected and measured insertion loss is an indicator of the efficacy of sound reduction for a given structure.

Sound passing through a plurality of layers comprising layers of alternating stiffness as characterized by flexural modulus is deadened to a greater extent than when passing through a single layer of a polymeric material. Surprisingly, effective sound deadening can be obtained even when the difference between flexural moduli is that provided by unfilled, polymeric materials, which is relatively small compared to prior sound deadening structures using a constraining layer with a very high flexural modulus such as steel, galvanized steel or aluminum. Such structures can be used advantageously for lightweight sound deadening applications.

The structure may comprise one layer comprising the stiff polymeric material and one layer comprising the soft polymeric material. The structure may further comprise an adhesive layer adjacent to the layer comprising the soft polymeric material that can be used to adhere the structure to a substrate. The adhesive layer may be a pressure-sensitive adhesive, a hot melt adhesive, or a coextrudable adhesive with a low melting range that can be used to adhere the structure to the substrate with application of heat or radio-frequency radiation. As used herein, “adjacent” means that the layers are near each other, either in direct contact or with an intervening layer between them.

When the structure comprising one stiff layer and one soft layer is adhered to a substrate with a high flexural modulus such as a door panel such that the soft layer is adjacent to the substrate, it provides a structure having “stiff-soft-stiff” architecture. Example sound deadened substrates include the following structures:

Substrate/soft layer/stiff layer; and

Substrate/adhesive layer/soft layer/stiff layer.

Although a two-layer structure may provide some sound deadening depending on its application, notably the multilayer structure has at least three layers of alternating stiffness. Such structures are described generally herein as structures comprising three layers of polymeric materials laminated such that the two outer layers are on either side of an inner layer, but structures of four or five layers or more are also contemplated. Notably, the structures comprise an odd number of layers so that a symmetrical structure is obtained.

The structure preferably has a “stiff layer-soft layer-stiff layer” construction wherein the stiff material is on the outside of the laminate and the soft layer is an inner layer. Such structures may be advantageous for handling the laminates, the stiff outer layers protecting the soft inner layer from blocking.

Example sound deadened substrates include the following structures:

Substrate/stiff layer/soft layer/stiff layer; and

Substrate/adhesive layer/stiff layer/soft layer/stiff layer.

Alternatively, the laminate may have “soft layer-stiff layer-soft layer” architecture wherein the soft layers are on the outside of the laminate and the stiff layer is an inner layer. Having a soft layer outside may be an advantage if it is desired to seal or bond the laminate to another surface such as for water protection.

As used herein, “stiff layers” are prepared from polymeric materials having a flexural modulus greater than 140 kpsi (965 MPa), such as from about 140 kpsi (965 MPa) to about 500 kpsi (3450 MPa), preferably from about 260 kpsi (1800 MPa) to about 500 kpsi (3450 MPa), and more preferably from about 300 kpsi (2070 MPa) to about 500 kpsi (3450 MPa). When a laminate comprises more than one stiff layer, the polymeric materials of each stiff layer may be the same or different, as may be the flexural moduli of the stiff layers.

“Soft layers” are prepared from polymeric materials having a flexural modulus of less than about 75 kpsi (517 MPa) such as about 1,000 psi (7 MPa) to about 60 kpsi (415 MPa), preferably from about 3 kpsi (21 MPa) to about 30 kpsi (207 MPa) or from about 3 kpsi (21 MPa) to about 15 kpsi (103 MPa).

The total thickness of the multilayer polymeric laminate may be about 40 mils (1.0 mm) or greater and preferably about 60 mils (1.5 mm) or greater. Many end uses require the multilayer polymeric laminate to be even thicker. Sound-proofing laminates thicker than 60 mils (1.50 mm), 90 mils (2.25 mm), and even thicker than 120 mils (3.00 mm), are becoming common in the marketplace.

Depending on the end use, the total thickness of the multilayer polymeric laminate may be about 40 mils (1.0 mm) to about 550 mils (14 mm), or from about 40 mils (1.0 mm) to about 250 mils (6.4 mm), or from about 60 mils (1.5 mm) to about 120 mils (3.0 mm)

For example, thickness of about 40 to about 150 mil (1.0 to 3.75 mm) or about 40 to about 100 mil (1.0 to 2.5 mm) may be useful for carpet backing. In some cases due to constrained spaces such as inside automobile doors, thinner laminates may be needed, such as about 40 to about 100 mil (1.0 to 2.5 mm)

Each outer layer may have a thickness of about 8 mil (0.2 mm) or greater, such as about 0.2 to about 1.8 mm. Inner layers may have a thickness of about 4 mils or greater, such as 0.1 to 2 mm. Preferably, the thickness of an inner layer is 20 mils (0.5 mm) or greater.

Desirably, the soft layer when used as an inner layer in a stiff-soft-stiff architecture comprises from 5 to 60% of the total thickness of the three-layer laminate, preferably from 15 to 55%, or from 20 to 50%, or from 30 to 50% of the total thickness.

A comparable commercial constrained layer sound damping sheet comprises a butyl based core with 4 mil aluminum constraining layer offered at 70 mils (1.75 mm) thickness with a density of 2.2 kg/m².

The multilayer polymeric laminate with the “stiff layer-soft layer-stiff layer” architecture may further comprise one or more pairs of layers of polymeric materials, each pair providing one stiff layer and one soft layer. Each pair has one layer of stiff polymeric material that has a modulus of about 140 kpsi (965 MPa) to about 500 kpsi (3450 MPa), preferably from about 260 kpsi (1800 MPa) to about 500 kpsi (3450 MPa), and more preferably from about 300 kpsi (2070 MPa) to about 500 kpsi (3450 MPa), and a thickness of about 1 mil (0.025 mm) or greater, such as about 10 mil (0.25 mm) or greater. The other, soft layer of polymeric material may have a modulus of about 1,000 psi (7 MPa) to about 15,000 psi (103 MPa), preferably from about 3,000 psi (21 MPa) to about 10,000 psi (69 MPa), and a thickness of about 1 mil or greater. Preferably, the thickness of this layer is 20 mils (0.5 mm) or greater. The outer layers of the resulting multilayer polymeric laminates are always stiff layers so that for a 5-layer laminate the additional pair of layers provides “stiff layer-soft layer-stiff layer-soft layer-stiff layer” architecture. In such laminates, the outer stiff layers may have a thickness of about 10 mil (0.25 mm) or greater to provide sufficient stiffness to the overall structure, while inner stiff layers may be somewhat thinner such as about 1 mil to about 5 mil (0.12 mm).

Similarly, laminates with “soft layer-stiff layer-soft layer” architecture may also comprise additional pairs of layers such that the outer layers are always soft layers so that for a 5-layer laminate the additional pair of layers provides “soft layer-stiff layer-soft layer-stiff layer-soft layer” architecture.

Preferably the multilayer structures provide sound deadening to a sound power level of less than 84 dBA for the band sum from 800 Hz to 20 KHz, preferably less than 83, more preferably less than 82.5 dBA, measured according to ISO 3744 “Acoustics—Determination of sound power levels of noise sources using sound pressure.” Preferably, the multilayers structures provide a sound power level of less than 77 dBA measured at 1000 Hz, preferably less than 74, more preferably less than 73 dBA.

Alternatively, the insertion loss may be greater than 20 dBA for the band sum from 800 Hz to 20 KHz, preferably greater than 21 dBA, more preferably greater than 22 dBA. Preferably, the multilayers structures provide an insertion loss of greater than 18 dBA measured at 1 kHZ, preferably more than 20, more preferably more than 22 dBA.

Polymers suitable for use as the stiff layers of the multilayer structure include ABS, Acetal homopolymer, polyacrylic, acrylonitrile, polyetheretherketone, polyamides such as nylon 6 and nylon 66, polycarbonate, polybutylene terephthalate, polyethylene terephthalate, polyethylene terephthalate glycolate, polyimide, polypropylene, polystyrene, or polyurethane. Many of these stiff materials are described as “engineering” polymers.

Preferred polymers for use in the stiff layers are polyamides. Polyamides (abbreviated herein as PA), also referred to as nylons, are condensation products of one or more dicarboxylic acids and one or more diamines, and/or one or more aminocarboxylic acids such as 11-aminododecanoic acid, and/or ring-opening polymerization products of one or more cyclic lactams such as caprolactam and laurolactam. Polyamides may be fully aliphatic or semiaromatic.

Polyamides from single reactants such as lactams or amino acids, referred to as AB type polyamides are disclosed in Nylon Plastics (edited by Melvin L. Kohan, 1973, John Wiley and Sons, Inc.) and include nylon-6, nylon-11, nylon-12, or combinations of two or more thereof. Polyamides prepared from more than one lactam or amino acid include nylon-6,12.

Other polyamides useful in the composition include those prepared from condensation of diamines and diacids, referred to as AABB type polyamides (including nylon-66, nylon-610, nylon-612), as well as from a combination of lactams, diamines and diacids such as nylon-6/66, nylon-6/610, nylon-6/66/610, nylon-66/610, or combinations of two or more thereof.

Fully aliphatic polyamides used in the resin composition are formed from aliphatic and alicyclic monomers such as diamines, dicarboxylic acids, lactams, aminocarboxylic acids, and their reactive equivalents. In this context, the term “fully aliphatic polyamide” also refers to copolymers derived from two or more such monomers and blends of two or more fully aliphatic polyamides. Linear, branched, and cyclic monomers may be used.

Carboxylic acid monomers comprised in the fully aliphatic polyamides include, but are not limited to aliphatic dicarboxylic acids, such as for example adipic acid (C6), pimelic acid (C7), suberic acid (C8), azelaic acid (C9), decanedioic acid (C10), dodecanedioic acid (C12), tridecanedioic acid (C13), tetradecanedioic acid (C14), and pentadecanedioic acid (C15). Diamines can be chosen among diamines with four or more carbon atoms, including but not limited to tetramethylene diamine, hexamethylene diamine, octamethylene diamine, decamethylene diamine, dodecamethylene diamine, 2 methylpentamethylene diamine, 2-ethyltetramethylene diamine, 2 methyloctamethylenediamine; trimethylhexamethylenediamine, meta-xylylene diamine, and/or mixtures thereof.

Semi-aromatic polyamides include a homopolymer, a copolymer, a terpolymer or more advanced polymers formed from monomers containing aromatic groups. One or more aromatic carboxylic acids may be terephthalic acid or a mixture of terephthalic acid with one or more other carboxylic acids, such as isophthalic acid, phthalic acid, 2-methyl terephthalic acid and naphthalic acid. In addition, the one or more aromatic carboxylic acids may be mixed with one or more aliphatic dicarboxylic acids, as disclosed above. Alternatively, an aromatic diamine such as meta-xylylene diamine (MXD) can be used to provide a semi-aromatic polyamide, an example of which is MXD6, a homopolymer comprising MXD and adipic acid.

Preferred polyamides disclosed herein are homopolymers or copolymers wherein the term copolymer refers to polyamides that have two or more amide and/or diamide molecular repeat units. The homopolymers and copolymers are identified by their respective repeat units. For copolymers disclosed herein, the repeat units are listed in decreasing order of mole % repeat units present in the copolymer. The following list exemplifies the abbreviations used to identify monomers and repeat units in the homopolymer and copolymer polyamides:
HMD hexamethylene diamine (or 6 when used in combination with a diacid)
T Terephthalic acid
AA Adipic acid
DMD Decamethylenediamine
6 ε-Caprolactam
DDA Decanedioic acid
DDDA Dodecanedioic acid
I Isophthalic acid
MXD meta-xylylene diamine
TMD 1,4-tetramethylene diamine
4T polymer repeat unit formed from TMD and T
6T polymer repeat unit formed from HMD and T
DT polymer repeat unit formed from 2-MPMD and T
MXD6 polymer repeat unit formed from MXD and AA
66 polymer repeat unit formed from HMD and AA
10T polymer repeat unit formed from DMD and T
410 polymer repeat unit formed from TMD and DDA
510 polymer repeat unit formed from 1,5-pentanediamine and DDA
6 polymer repeat unit formed from ε-caprolactam
610 polymer repeat unit formed from HMD and DDA
612 polymer repeat unit formed from HMD and DDDA
11 polymer repeat unit formed from 11-aminoundecanoic acid
12 polymer repeat unit formed from 12-aminododecanoic acid

In the art the term “6” when used alone designates a polymer repeat unit formed from ε-caprolactam. Alternatively “6” when used in combination with a diacid such as T, for instance 6T, the “6” refers to HMD. In repeat units comprising a diamine and diacid, the diamine is designated first. Furthermore, when “6” is used in combination with a diamine, for instance 66, the first “6” refers to the diamine HMD, and the second “6” refers to adipic acid. Likewise, repeat units derived from other amino acids or lactams are designated as single numbers designating the number of carbon atoms.

Notable polyamides include PA6, PA66, PA610, PA612, PA6/66, PA6/610, PA6/66/610, PA6/6T, PA11 and PA12.

The soft layer may comprise polybutylene, low density polyethylene or ethylene copolymers with polar comonomers comprising copolymerized units of ethylene and a comonomer selected from a vinyl ester such as vinyl acetate, an α,β-unsaturated monocarboxylic acid or its derivative, an α,β-unsaturated dicarboxylic acid or its derivative, an epoxide-containing monomer, or combinations of two or more thereof; wherein the polymer contains copolymerized units of 2 to 80 weight % of the comonomer.

The ethylene copolymer used as the soft layer can be a dipolymer, a terpolymer, a tetrapolymer, or combinations thereof. In particular, it may be a copolymer having copolymerized units of ethylene and a comonomer selected from vinyl esters and α,β-unsaturated monocarboxylic acid esters wherein the polymer contains copolymerized units of at least 2 weight % of the comonomer. Preferably at least one comonomer in the copolymer is vinyl acetate, an alkyl acrylate and/or an alkyl methacrylate.

When the ethylene copolymer is an ethylene vinyl acetate copolymer, the percentage of copolymerized vinyl acetate units can vary broadly from 2% to as much as 40 weight % of the total weight of the copolymer or even higher.

The weight percentage of copolymerized vinyl acetate units in the copolymer is preferably from 2 to 50 weight %, such as from 10 to 40 weight %. The ethylene/vinyl acetate copolymer preferably has a melt flow rate, measured in accordance with ASTM D-1238 at 190° C. with 2.16 kg pressure, from about 0.1 to about 40 g/10 minutes, and preferably from about 0.3 to about 30 g/10 minutes.

Preferably, the ethylene vinyl acetate composition comprises a poly(ethylene-co-vinyl acetate) polymer, and the poly(ethylene-co-vinyl acetate) polymer comprises at least about 25 wt % of copolymerized repeat units derived from vinyl acetate, based on the total weight of the poly(ethylene-co-vinyl acetate) polymer, such as between 30 and 50 wt % of copolymerized repeat units derived from vinyl acetate; or wherein the poly(ethylene-co-vinyl acetate) polymer has a melt flow index of about 14 g/10 min as measured by ASTM Method No. D1238-13 at a temperature of 190° C. and under a load of 2.16 kg.

Ethylene vinyl acetate copolymers are commercially available from E. I. du Pont de Nemours and Company (DuPont), Wilmington, Del. under the Elvax® tradename.

A mixture of two or more different ethylene/vinyl acetate copolymers can be used in place of a single copolymer as long as the average values for the weight percentage of vinyl acetate comonomer units, based on the total weight of the copolymers, is within the range indicated above. Particularly useful properties may be obtained when two or more properly selected ethylene/vinyl acetate copolymers are used in the binder compositions.

The ethylene copolymer component may also be an ethylene alkyl acrylate or ethylene alkyl methacrylate copolymer. The terms “ethylene/alkyl(meth)acrylate copolymer” and “ethylene(meth)acrylate copolymer” are used interchangeably herein and mean a thermoplastic copolymer derived from the copolymerization of ethylene and at least one alkyl acrylate or alkyl methacrylate comonomer, wherein the alkyl group contains from 1 to 8 carbon atoms, preferably from 1 to 4 carbon atoms. Examples of alkyl acrylates suitable for use include, without limitation, methyl acrylate, ethyl acrylate and butyl acrylate and examples of alkyl methacrylates include methyl methacrylate, ethyl methacrylate and butyl methacrylate.

The relative amount of the alkyl(meth)acrylate comonomer incorporated as copolymerized units into the ethylene/alkyl(meth)acrylate copolymer can vary broadly from a few weight % to as much as 45 weight %, based on the weight of the copolymer or even higher. Notably, the level of copolymerized units of alkyl(meth)acrylate comonomer in the ethylene/alkyl(meth)acrylate copolymer is within the range of from 5 to 45 weight %, preferably from 5 to 35 weight %, from 5 to 30, still more preferably from 9 to 28 weight % or from 10 to 27 weight % of the total ethylene/(meth)acrylate copolymer, based on the weight of the copolymer. Methyl acrylate (the most polar alkyl acrylate comonomer) can be used to prepare an ethylene/methyl acrylate dipolymer. The methyl acrylate comonomer can be present in a concentration range of from 5 to 30, 9 to 25, or 9 to 24 weight %, of the ethylene copolymer.

The ethylene/(meth)acrylate copolymer preferably has a melt flow rate or melt index, measured in accordance with ASTM D-1238 at 190° C. with 2.16 kg pressure, from about 0.1 to about 40 g/10 minutes, and preferably from about 0.3 to about 30 g/10 minutes.

Mixtures of ethylene/alkyl(meth)acrylate copolymers may also be used, so long as the level of copolymerized units of (meth)acrylate is within the above-described range, based on the total weight of copolymer present.

A mixture of two or more ethylene copolymers can be used in the compositions in place of a single copolymer. Particularly useful properties may be obtained when two properly selected ethylene/alkyl acrylate copolymers are used in blends. For example but not limitation, compositions include those wherein the ethylene/alkyl acrylate component comprises two different ethylene/methyl acrylate copolymers. Also for example, one may replace a single EMA grade in a blend with an equal amount of a properly selected mixture of two EMA grades, where the mixture has the same weight percent methyl acrylate content and melt index as the single EMA grade replaced. By combining two different properly selected EMA copolymer grades, modification of the properties of the composition may be achieved as compared with compositions containing only a single EMA resin grade.

Ethylene copolymers suitable for use herein can be produced by any process, including processes that involve use of a tubular reactor or an autoclave. Copolymerization processes conducted in an autoclave may be continuous or batch processes. In one such process, disclosed in general in U.S. Pat. No. 5,028,674, ethylene, the alkyl acrylate, and optionally a solvent such as methanol and/or a telogen such as propane to control the molecular weight, are fed continuously into a stirred autoclave such as the type disclosed in U.S. Pat. No. 2,897,183, together with an initiator. Ethylene/alkyl acrylate copolymers produced using an autoclave process can be obtained commercially, for example from Exxon/Mobil Corp, and/or from Elf AtoChem North America, Inc.

As generally recognized in the art, a tubular reactor copolymerization technique will produce a copolymer having a greater relative degree of heterogeneity along the polymer backbone (a more blocky distribution of comonomers), will tend to reduce the presence of long chain branching and will produce a copolymer characterized by a higher melting point than one produced at the same comonomer ratio in a high pressure stirred autoclave reactor. Tubular reactor produced ethylene/(meth)acrylate copolymers of this nature are commercially available from DuPont under the Elvaloy® AC tradename.

The ethylene copolymers may also include at least one comonomer such as epoxide-containing monomer or an α,β-unsaturated dicarboxylic acid or its derivative. An epoxide-containing monomer can include glycidyl methacrylate, glycidyl acrylate, or combinations thereof. An example is an ethylene glycidyl methacrylate copolymer. An α,β-unsaturated dicarboxylic acid or its derivative can include maleic acid, fumaric acid, itaconic acid, a C₁-C₄ alkyl monoester of maleic acid, a C₁-C₄ alkyl monoester of fumaric acid, a C₁-C₄ alkyl monoester of itaconic acid, acid anhydride, or combinations of two or more thereof. An example is a copolymer of ethylene and monoethyl maleic acid ester. Terpolymers may also be used. For example, ethylene, vinyl ester or an α,β-unsaturated ester and maleic anhydride, glycidyl methacrylate or carbon monoxide can be copolymerized to form terpolymers such as ethylene/methyl acrylate/maleic anhydride, ethylene/butyl acrylate/glycidyl methacrylate (EBAGMA), ethylene/butyl acrylate/carbon monoxide (EBACO) or ethylene/vinyl acetate/carbon monoxide (EVACO).

Ethylene acid copolymers comprising in-chain copolymerized units of ethylene and in-chain copolymerized units of an α,β-unsaturated C₃-C₈ monocarboxylic acid are also suitable for use as the soft layer.

The β,β-unsaturated C₃-C₈ monocarboxylic acid may be acrylic acid or methacrylic acid, and the monocarboxylic acid may be present in the copolymer in an amount from about 3 to about 30 weight %, or about 3 to about 12 weight %, or about 12 to about 20 weight %, or about 4 to about 15 weight % of the copolymer, or about 15 to about 30 weight %.

The ethylene acid copolymer may also optionally include other comonomers such as alkyl acrylates and alkyl methacrylates wherein the alkyl groups have from 1 to 8 carbon atoms such as methyl acrylate, ethyl acrylate and n-butyl acrylate. These comonomers, when present, can be from 0.1 to about 30% based on the total weight of the copolymer, or about 3 to about 25%, such as from 3 to about 13 weight % or about 14 to about 25 weight %. The optional alkyl acrylates and alkyl methacrylates provide softer acid copolymers that after neutralization form softer ionomers.

Of note are ethylene acid dipolymers consisting essentially of copolymerized units of ethylene and copolymerized units of monocarboxylic acid (that is, the amount of alkyl acrylate or alkyl methacrylate is 0 weight %), and ionomers thereof. Preferably the monocarboxylic acid is acrylic acid or methacrylic acid. Also of note are terpolymers consisting essentially of copolymerized units of ethylene, acrylic acid or methacrylic acid and an alkyl acrylate or alkyl methacrylate.

The acid copolymers may be obtained by high-pressure free radical polymerization, wherein the comonomers are directly copolymerized with ethylene by adding all comonomers simultaneously. This process provides copolymers with “in-chain” copolymerized units derived from the monomers, where the units are incorporated into the polymer backbone or chain. These copolymers are distinct from a graft copolymer, in which the acid comonomers are added to an existing polymer chain via a post-polymerization grafting reaction, often by a free radical reaction.

The acid copolymers may also be at least partially neutralized to salts comprising alkali metal cations such as sodium or lithium, or zinc cations, or a combination of such cations to prepare ionomers. The acid copolymers are treated so that at least some of the carboxylic acid groups present are neutralized to form salts with zinc or alkali metal cations to provide ionomers useful in the compositions described herein.

Neutralization of an ethylene acid copolymer can be effected by first making the ethylene acid copolymer and treating the copolymer with basic compound(s) comprising alkali metal, alkaline earth, or transition metal cations. The copolymer may be neutralized so that from about 10 to about 90%, preferably 30 to 90% of the available carboxylic acid groups in the copolymer are neutralized to salts, such as with at least one metal ion selected from lithium, sodium, potassium, magnesium zinc, or combinations of such cations. For example, from about 10 to about 70 or about 30 to about 70% of the available carboxylic acid groups may be ionized by treatment with basic compound(s) (neutralization) with at least one metal ion selected from lithium, sodium, zinc, or magnesium.

Non-limiting, illustrative examples of ethylene acid copolymers useful in ionomers include E/15MAA, E/19MAA, E/15AA, E/19AA, E/15MAA, E/19MAA, E/10MAA/4iBA, Ell OMAA/9.8iBA, E/9MAA/23nBA, (wherein E represents ethylene, MAA represents methacrylic acid, AA represents acrylic acid, iBA represents isobutyl acrylate, nBA represents n-butyl acrylate, and the numbers represents the weight % of comonomers present in the copolymer).

Of note are ionomers of an ethylene acid copolymer comprising or consisting essentially of copolymerized units of ethylene, about 15 to about 30 weight % of copolymerized units of a C₃₋₈ α,β-ethylenically unsaturated carboxylic acid, and about 3 to about 13 weight % of copolymerized units of a softening comonomer selected from the group consisting of vinyl acetate, alkyl acrylate and alkyl methacrylate; wherein the acid moieties in the acid copolymer are nominally neutralized to a level from about 15% to about 30%.

Suitable ionomers are sold under the trademark Surlyn® by DuPont.

The ethylene-containing copolymers useful in the compositions described herein can be modified by methods well known in the art, including chemical reaction by grafting with an unsaturated carboxylic acid or its derivatives, such as maleic anhydride or maleic acid.

Notably, the ethylene copolymer is an ethylene methyl acrylate dipolymer, ethylene ethyl acrylate dipolymer, ethylene butyl acrylate dipolymer, ethylene methyl acrylate glycidyl methacrylate terpolymer, ethylene butyl acrylate glycidyl methacrylate terpolymer, or combinations of two or more thereof.

In some embodiments, the soft layer may comprise more than one layer. For example, the soft inner layer may comprise two or more layers of ethylene copolymers, which may be the same or different. A specific example is a soft inner layer comprising an innermost layer of ethylene vinyl acetate between two additional ethylene vinyl acetate layers, resulting in a five-layer structure when combined with two stiff outer layers, such as outer layers comprising polyamides.

Alternatively, the soft layer may comprise two outer layers comprising ionomeric composition(s) positioned on either side of an inner layer comprising an ethylene vinyl acetate composition. The outer ionomer-comprising layers can be ionomers of dipolymers or terpolymers, for example. The ethylene vinyl acetate copolymer and the ionomers in the 3-layer soft layer structure may comprise the materials described above.

Compositions suitable for use in the soft layers of this invention are described in greater detail in PCT Application Publications WO2014/100301, WO2014/100309 and WO2014/100313, U.S. patent applications Ser. Nos. 14/560,663 and 14/573,170, and International Patent Applications PCT/US2014/047547 and PCT/US2014/068777.

The laminates may further comprise one or more layers of polymeric material to provide added features. Additional layers may serve as barrier layers, tie layers, adhesive layers, antiblocking layers, or for other purposes.

For example, functional copolymers such as maleic-anhydride graft copolymers can be used in tie layers positioned between a stiff layer and a soft layer to provide improved adhesion between the stiff layers and the soft layers or in adhesive layers to provide adhesion to a substrate. Tack adhesion, also called ‘handling bond,’ is the minimum adhesion required between layers of a coextruded film or sheet to enable it to be handled (conveyed, wound, and unwound) without delaminating. An industry standard for sufficient adhesion is a force of 1 pli (17.86 kg/m).

Maleic anhydride-grafted polymers (maleated polymers) are polymeric materials in which maleic anhydride is reacted with an existing polymer, often under free-radical conditions, to form anhydride groups appended to the polymer chain. They include maleated polyethylene including maleated linear low density polyethylene, maleated polypropylene, maleated styrene-ethylene-butene-styrene triblock copolymer, maleated ethylene vinyl acetate copolymers or maleated polybutadiene. Maleated copolymers are available commercially from DuPont under the Bynel® tradename.

Other suitable functional polymers for use in adhesive or tie layers include ethylene copolymerized with a functional comonomer comprising an ethylenically unsubstituted dicarboxylic acid or derivative thereof, selected from the group consisting of maleic anhydride; itaconic anhydride; maleic acid diesters; fumaric diesters; maleic acid monoesters or fumaric acid monoesters, including esters of C₁ to C₄ alcohols, such as, for example, methyl, ethyl, n-propyl, isopropyl, and n-butyl alcohols; maleic acid, itaconic acid; fumaric acid; or mixtures of any of these. The functional comonomer can be maleic anhydride, or monoesters and/or diesters of maleic acid. The copolymers may also comprise a third comonomer selected from the group consisting of vinyl acetate, acrylic acid, methacrylic acid, alkyl acrylate and methyl acrylate.

These copolymers can be obtained directly from the monomers by high-pressure free radical polymerization processes, described, for example, in U.S. Pat. No. 4,351,931. In contrast to graft copolymers such as the maleated polymers described above, portions of the units derived from the functional comonomers form part of the polymer chain and are not appended to a pre-existing chain.

Exemplary embodiments include the multilayer structures and articles further comprising at least one tie layer comprising maleated polyethylene, maleated polypropylene, maleated styrene-ethylene-butene-styrene triblock copolymer, maleated ethylene vinyl acetate, maleated polybutadiene, or ethylene copolymers wherein ethylene is copolymerized with a functional comonomer selected from the group maleic anhydride; itaconic anhydride; maleic acid diesters; fumaric diesters; maleic acid monoesters and fumaric acid monoesters, including esters of C₁ to C₄ alcohols, such as, for example, methyl, ethyl, n-propyl, isopropyl, and n-butyl alcohols; maleic acid, itaconic acid; fumaric acid; or mixtures of any of these. An example is an ethylene copolymer where ethylene is copolymerized with a maleic acid monoester.

A specific example is a five layer structure comprising an inner layer of an ethylene vinyl acetate copolymer, two outer layers comprising nylon and two tie layers each individually positioned between the inner layer and the outer layers.

Other embodiments may comprise blends of the ethylene copolymer and a maleated polymer as the soft layer and/or a tie layer. The blends may comprise from about 5 to about 95%, or about 10 to about 90%, or about 20 to about 80%, of one or more ethylene copolymers with the maleated polymer in a complementary amount. A specific example of a blend is a blend of about 90% of an ethylene vinyl acetate copolymer with about 10% of maleated polyethylene. Use of such blends may improve interlayer adhesion without needing to have discreet tie layers in the structure. Alternatively, the soft layer may comprise or consist essentially of a maleated polymer as described above.

The compositions used in the invention may be used with additives known in the art, including plasticizers, processing aides, flow enhancing additives, lubricants, pigments, dyes, flame retardants, impact modifiers, nucleating agents to increase crystallinity, antiblocking agents such as silica, thermal stabilizers, UV absorbers, UV stabilizers, dispersants, surfactants, chelating agents, coupling agents, and primers.

The compositions of the various layers may incorporate an effective amount of a thermal stabilizer. Any thermal stabilizer known in the art will find utility. The compositions of the invention mayincorporate from 0.1 to about 10 weight %, from 0.1 to about 5 weight % thermal stabilizers, or from 0.1 to about 1 weight % thermal stabilizers, based on the total weight of the composition.

The compositions of the invention may further incorporate additives that effectively reduce the melt flow of the resin, to the limit of producing thermoset layers. The use of such additives will enhance the upper end use temperature of the multilayer polymeric laminate. Typically, the end use temperature will be enhanced 20° C. to 70° C. In addition, laminates produced from such materials will be fire resistant. By reducing the melt flow of the compositions of the multilayer polymeric laminate, these compositions have a reduced tendency to melt and flow out of the laminate and, in turn, serve as additional fuel for a fire. Examples of melt flow reducing additives are organic peroxides. Preferably the organic peroxide decomposes at a temperature of about 100° C. or higher to generate radicals. More preferably, the organic peroxides have a decomposition temperature which affords a half life of 10 hours at about 70° C. or higher to provide improved stability for blending operations. Typically, the organic peroxides will be added at a level of between about 0.01 to about 10 weight % based on the total weight of the ethylene copolymer composition. If desired, initiators, such as dibutyltin dilaurate, may be used. Typically, initiators are added at a level of from about 0.01 weight % to about 0.05 weight % based on the total weight of the ethylene copolymer composition. If desired, inhibitors, such as hydroquinone, hydroquinone monomethyl ether, p-benzoquinone, and methylhydroquinone, may be added for the purpose of enhancing control of the reaction and stability. Typically, the inhibitors would be added at a level of less than about 5 weight % based on the total weight of the composition.

Notably, the compositions of the soft layers do not include inorganic fillers which would increase the density and stiffness of such layers.

The compositions of the stiff layers may optionally incorporate low density fillers such as wood flour or refractory mineral fibers (Industrial Inorganic Chemistry by Karl Heinz Büchel, Hans-Heinrich Moretto and Dietmar Werner, published by Wiley, 2000, p 372) to increase stiffness, with little impact on density. Other low density fillers include hollow microspheres made of glass, plastic, ceramic, carbon, alumino-silicate (cenospheres or plerospheres available from fly ash). See http://www.compositesworld.com/articles/microspheres-fillers-filled-with-possibilities for additional information.

The multilayer polymeric laminates may be formed through lamination, coextrusion, calendering, injection molding, blown film, dipcoating, solution coating, solution casting, blade, puddle, air-knife, printing, Dahlgren, gravure, powder coating, spraying, and other art processes. The parameters for each of these processes can be easily determined by one of ordinary skill in the art depending upon viscosity characteristics of the polymeric materials and the desired thickness of the layers of the laminate. Preferably, the multilayer polymeric laminates are produced through coextrusion processes or lamination processes.

A lamination process to produce the multilayer polymeric laminates may involve forming a pre-press assembly, i.e., stacking the preformed layers in the desired order, followed by lamination. Any lamination process or combination of processes may be utilized, such as, for example, tie layer lamination, solvent lamination, heat lamination and combinations thereof. Preferably, the preformed layers incorporate rough surfaces to facilitate deairing during lamination processes.

Preferably, the multilayer sheets can be made by coextrusion, or by extrusion lamination. In coextrusion, molten polymers flow though a die and make the sheet in a single step. This provides a more efficient process by avoiding of the formation of a pre-press assembly and through reduced vacuum requirements during the lamination process. Coextrusion is particularly preferred for formation of “endless” products, such as sheets, which emerge as a continuous length. In coextrusion, usually each layer composition is provided from an individual extruder. If two or more of the layer compositions to be incorporated within the multilayer polymeric laminate are identical, they may be fed from the same extruder or from individual extruders, as desired. For each layer composition, the polymeric material, whether provided as a molten polymer or as thermoplastic pellets or granules, is fluidized and homogenized. Additives, as described above, may be added if desired. Preferably, the melt processing temperature of the polymeric compositions used in this invention is from about 50° C. to about 300° C., more preferably, from about 100° C. to about 250° C. The polymeric compositions described herein have excellent thermal stability, which allows for processing at high enough temperatures to reduce the effective melt viscosity. Recycled polymeric compositions may be used along with the virgin polymeric compositions. The molten materials are conveyed to a coextrusion adapter that combines the molten materials to form a multilayer coextruded structure. The layered polymeric material is transferred through an extrusion die opened to a predetermined gap. Die openings may be within a wide range. The extruding force may be exerted by a piston or ram (ram extrusion), or by a rotating screw (screw extrusion), which operates within a cylinder in which the material is heated and plasticized and from which it is then extruded through the die in a continuous flow. Single screw, twin screw, and multi-screw extruders may be used as known in the art. Different kinds of dies are used to produce different products, such as sheets and strips (slot dies) and hollow and solid sections (circular dies). Generally, a slot die, (T-shaped or “coat hanger” die), is utilized to produce multilayer sheets. The die may be as wide as 10 feet and typically have thick wall sections on the final lands to minimize deflection of the lips from internal pressure.

The multilayer polymeric sheets are then drawn down to the intended gauge thickness by means of a primary chill or casting roll maintained typically in the range of about 15° C. to about 55° C. The nascent multilayer cast sheet may be drawn down, and thinned significantly, depending on the speed of the rolls taking up the sheet. Typical draw down ratios range from about 1:1 to about 5:1 to about 40:1. The multilayer polymeric laminate sheet is then taken up on rollers or as flat sheets, cooled and solidified. This may be accomplished by passing the sheet through a water bath or over two or more chrome-plated chill rolls that have been cored for water cooling. The cast multilayer polymeric laminate sheet is then conveyed though nip rolls, a slitter to trim the edges, and then wound up or cut and stacked while preventing any subsequent deformation of the sheet.

As discussed above, blends of ethylene copolymer with a functionalized copolymer may be used as the soft layer composition to improve adhesion to the stiff layer. For example, a coextruded structure might have nylon/EVA+maleated polymer/nylon, wherein “/” represents a layer-to-layer interface.

The layer components can readily be coextruded onto a substrate, such as automotive carpet, foam, fabric or scrim material, or can be coextruded or calendered as unsupported film or sheet according to standard methods. Depending upon the equipment used, and the compounding techniques employed, it is possible to extrude a wide range of sheet thickness, from about 20 mils to above 100 mils.

In extrusion lamination, the inner layer is extruded in molten form between two preformed outer layers. As the inner layer cools it adheres to the outer layers to form the final multilayer structure. The outer layers may be fed to the extrusion lamination as films unwound from rolls. It is also possible to extrude films or sheets of the two outer layers and subsequently bring them together with the inner layer by tandem extrusion lamination.

In extrusion lamination, it may be necessary to use a soft layer comprising a blend of a base polymer such as EVA with a functionalized polymer or a functionalized copolymer alone as the soft layer because adhesion is more difficult when the other layers are already formed and cooled. An example structure prepared by extrusion lamination may be nylon/functional polymer/nylon.

The multilayer sheets described herein can be further manipulated to provide sound-deadening articles for use in automobiles and other machinery subject to the need to reduce noise, vibration and harshness. Accordingly, the invention also provides a method for providing sound deadening to a substrate comprising

(1) preparing a multilayer structure as described above; and

(2) combining the multilayer structure with the substrate.

As used herein, “combining the multilayer structure with the substrate” includes adhering, bonding, or attaching the multilayer structure to the substrate. “Adhering or bonding” includes the use of pressure-sensitive adhesives, hot melt adhesives or bonding the multilayer substrate by extrusion coating, heat sealing or radio-frequency welding. “Attaching” includes affixing the multilayer structure to the substrate by mechanical fasteners such as clamps, screws, clips, or the like. Attaching also includes holding the multilayer structure against the substrate without adhering or bonding with other materials such as films or covers. Combining also includes underlaying or overlaying the multilayer structure onto the substrate.

The structures described herein can be processed industrially into final sheet, film or three-dimensional solid form by using standard fabricating methods well known to those skilled in the art. Thus, fabricating methods such as extrusion, calendering, extrusion coating, sheet laminating, cutting, die-cutting, stamping, sheet thermoforming, etc. are all practical means for forming the compositions of this invention into sound-deadening articles.

In view of the improved characteristics of the multilayer structures of this invention (e.g., sound deadening performance comparable to incumbent products with lighter weight or reduced thickness), they will be useful in the sheeting field, particularly for low cost, lightweight sound-deadening structures. A moldable sound barrier can be used in sound deadening applications including transport systems such as automobiles, motorcycles, buses, tractors, trains, trams, airplanes, and the like. When applied to automotive carpet, structures described herein are an effective and economic means to deaden sound, while also simultaneously serving as a moldable support for the carpet. For example, the multilayer structure of this invention can be bonded to a top coating, such as Advantech™ 8800D ethylene elastomer, to form a flooring system for the automotive industry. The application of the multilayer structures of the invention in carpets, and particularly in automotive carpets, is similar to methods already described in U.S. Pat. No. 4,191,798.

The components of the multilayer structures of the invention are generally not covalently cross-linked or cured, unless desired during end-product production as described above. Further, the compositions are thermoplastic in nature and therefore can be recycled after processing. The recycled material can also contain textile fibers, jute, etc., that may be present in the trim obtained during production of the finished product (e.g., automotive carpet backing).

When used in sheet form, especially when coated onto a fabric, the multilayer structures can be installed in areas of an automobile, truck, bus, etc., such as side panels, door panels, roofing areas, headliners and dash insulators. It is very desirable in modern vehicles to include sound deadening sheet in the door panels. In this case, it is advantageous that the sheet is moldable or themoformable and to adhere to the inside of the door so that the sheet can protect electronic components inside the door (e.g., window lifters, door locks, fasteners for door handles) from water ingress.

The structures of this invention may also be used in automotive door and trunk liners, rear seat restrainers, wheel well covers, carpet underlayments, and dash mats.

For example, the sound-reducing sheets can be overlaid on a body panel such as a door panel, dashboard panel or floor pan and then attached to the panel by application of heat and/or pressure. If the body panel is provided with a three-dimensional shape including various concavities or holes, the multilayer sheet can be draped over the body panel and then formed into the concave portions of the body panel by means of a heated press to conform to the shape of the panel. Holes can be cut into the sheet to match corresponding holes in the body panel either prior to thermoforming or simultaneously.

In some cases, use of a film comprising a thermoplastic elastomer (TPE) may aid in attaching the sound deadening sheet to the panel. The TPE film may be overlaid on the sound-deadening structure so that the sound-deadening structure is positioned between the panel and the TPE film. The film may have an area larger than the area of the sound-deadening structure so that portions of the TPE film may contact the panel directly and adhere to the panel, thereby holding the sound-deadening structure in place.

Alternatively, the sound deadening structure may be attached to a substrate by mechanical means such as clips, clamps, pins, screws or other mechanical fasteners.

For use in a carpet underlayment or other generally flat object, the multilayer structure can be coextrusion coated or laminated to a substrate such as a carpet backing. Alternatively, if the sound deadening structure is to be laid generally horizontally in its end-use configuration, it may be simply laid out on a body panel and held in place by gravity or mechanical means.

The multilayer structures can also be used as drapes or hangings to shield or to surround a noisy piece of factory equipment such as a loom, a forging press, conveyor belts and material transfer systems, etc.

The structures of this invention can also be used for sound deadening in small and large appliances, including dishwashers, refrigerators, air conditioners, and the like; household items such as blender housings, power tools, vacuum cleaning machines, and the like; lawn and garden items such as leaf blowers, snow blowers, lawn mowers, and the like; small engines used in boating applications such as outboard motors, water-jet personal watercraft, and the like. Additional applications include devices for modifying the sound of drums, loudspeaker systems, acoustically damped disc drive systems, and the like. For example, it may be desirable to isolate the sound from loudspeakers from other structures in an automobile to reduce undesirable vibration or sound distortion.

In construction and building industries, structures of this invention can be used as wallpapers, wallcoverings, composite sound walls, thermoformable acoustical mat compositions, vibration-damping constrained-layer constructions, and sound insulation moldable carpets. The multilayer structures may be faced with another material and can be used to achieve both a decorative and a functional use, such as dividing panels in an open-format office. An advantage of the structures of this invention is that certain physical properties, such as flexibility and toughness, which are typically reduced when fillers are added to polymers, can be maintained while providing low weight sound deadening.

### EXAMPLES AND COMPARATIVE EXAMPLES

The following Examples are presented to more fully demonstrate and further illustrate various aspects and features of the invention. As such, the Examples are not intended to limit the scope of the invention in any way.

### Materials

GRAFT-1: an ethylene vinyl acetate copolymer modified with maleic anhydride, melt flow rate (190° C., 2.16 kg) of 2.0 g/10 min.
GRAFT-2: a linear low density modified with maleic anhydride, melt flow rate (190 C, 2.16 kg) of 2.7 g/10 min.
EVA-1: An ethylene vinyl acetate copolymer with 9.3 weight % of vinyl acetate, melt flow rate (190° C., 2.16 kg) of 2 g/10 min.
EVA-2: An ethylene vinyl acetate copolymer with 12 weight % of vinyl acetate, melt flow rate (190° C., 2.16 kg) of 2.5 g/10 min and flexural modulus of 13.2 kpsi.
EVA-3: An ethylene vinyl acetate copolymer with 12 weight % of vinyl acetate, melt flow rate (190° C., 2.16 kg) of 3 g/10 min and flexural modulus of 4.1 kpsi.
EMA-1: An ethylene methyl acrylate copolymer with 24 weight % of methyl acrylate, melt flow rate (190° C., 2.16 kg) of 2 g/10 min.
PA-1: nylon-666 available commercially under the tradename Ultramid® C33 from BASF, with tensile modulus measured according to ISO 527 (molded specimen) of 2200 MPa and flexural modulus according to ASTM D790 at 73° F. of 435 kpsi. ISO 527 is comparable to ASTM D 638.
PA-2: nylon-6 available commercially under the tradename Aegis H85NP from Honeywell, with tensile modulus according to ASTM D882 (molded specimen) of 3300 MPa and flexural modulus according to ASTM D790 at 73° F. of about 400 kpsi.
F-1: Filled ethylene copolymer, density of 2.0 g/cc, melt flow rate (190° C., 2.16 kg) of 3 g/10 min.
F-2: Filled ethylene copolymer, density of 1.9 g/cc, melt flow rate (190° C., 2.16 kg) of 2 g/10 min.

### Analytical Methods

### Modulus

All moduli of soft materials were determined using molded specimens according to ASTM D 638-03 (2003) or were obtained from published sources.

### Peel Test

Peel testing may be performed by separating the layers to provide a small tab and then pulling the layers apart. The structures can be characterized qualitatively as “weak bond” or “could not separate”. The peel strength is more relevant to web handling and less to acoustic performance

### Acoustic Sound Power Determination

Acoustic testing was conducted according to ISO 3744 “Acoustics—Determination of sound power levels of noise sources using sound pressure.” This testing is more realistic than impedance tube (transmission loss) measurements.

An acoustic box was used to simulate diffusion of sound input. The test apparatus included a speaker box on which 15.24-cm×15.24-cm (6 inch×6 inch) test sheets were placed where the sound emanated from the speaker box. Sound was measured using ten microphone positions on an one-meter hemisphere above and around the sample. For this test apparatus, 1 KHz is the resonance frequency. Resonance frequency is affected by sample size, so for a sample larger in area, resonance frequency is lower. The sound power level had maxima at about 1 kHz, 2 kHz, 3 kHz and 6 kHz. The sound power level was measured as proportionate to the area under the curve from 800 Hz to 20 kHz and as the peak height at 1 kHz. The baseline sound power level with no sample was 104.5 dBa for the band sum from 800 Hz to 20 kHz and 95.1 at 1 kHz. Reduction of sound power at low frequency is difficult with incumbent sound deadening technology. For a test sample, the lower the sound power level, the better the sound deadening. The measured insertion loss was the difference between the measurement with no sample and the measurement with a sample. For comparison between samples at a given frequency and a given area, the expected insertion loss can be calculated using the formula below based on the normal incidence mass law.

Expected ILₛₐₘₚₗₑ=Measured IL_{Reference}+20×log 10(Massₛₐₘₚₗₑ/Mass_{Reference.}

To analyze the effectiveness of sound deadening compared to the density of the material in this test setup, the Insertion Loss Factor (ILF) was calculated by dividing the mass of the sample by the measured insertion loss. The lower the Insertion Loss Factor, the more effective sound deadening was per gram of material. This is important when lightweighting of vehicles is considered.

Comparative Examples summarized in Table 1 are commercially available filled sound-deadening materials. Density of filled samples may range from about 1.4 g/cm³ to about 2.2 g/cm³. The sound power level was determined as the band sum from 800 Hz to 20 kHz. The expected insertion loss was determined according to the formula above using the thin F-1 sample as the reference material.

TABLE 1

| | F-1 | | F-2 | |
|---|---|---|---|---|
| | Thin | Thick | Thin | Thick |
| Thickness (mm) | 1.55 | 2.52 | 1.60 | 2.61 |
| Area (cm²) | 232.26 | 232.26 | 232.26 | 232.26 |
| Volume (cm³) | 36.0 | 58.6 | 37.2 | 60.5 |
| Mass (g) | 77.57 | 130.5 | 77.80 | 132.30 |
| Density (g/cm³) | 2.15 | 2.23 | 2.09 | 2.19 |
| Mass per unit area (g/cm²) | 0.334 | 0.562 | 0.335 | 0.570 |
| Sound Power Level (dBA) | 82.4 | 79.1 | 82.3 | 78.4 |
| Insertion Loss (measured) | 22.1 | 25.4 | 22.2 | 26.1 |
| Insertion Loss (expected) | 22.1 | 26.6 | 22.1 | 26.7 |
| Insertion Loss Factor (g/dBA) | 3.51 | 5.14 | 3.50 | 5.07 |

The results from acoustic testing show that for filled samples prepared from F-1 and F-2, the sound power level declines (insertion loss increases) with density and thickness of the sheets. It can be seen that the Insertion Loss Factor increased for the thicker samples. This suggests that sound deadening efficacy decreases as the thickness increases above a certain thickness for these highly filled materials.

Multilayer structures with “stiff layer-soft layer-stiff layer” architecture were produced by coextrusion of the materials summarized in Table 2.

Coextruded samples were prepared on 1.5-inch (3.8 cm) extruder produced by Davis Standard. The extruder screws are general purpose screw with L/D 27/1 and compression ratio of 3/1. Three-layer samples consisting of the same resin on both of the outer layers (i.e., A-B-A structures) were prepared by splitting the output from one of the extruders in the die block. Five-layer samples (i.e., C-B-A-B-C structures) were prepared by splitting the flow from two of the extruders in the die block. Typical extruded temperature profiles (° F.) are shown below.

| | Run 1 | | Run 2 | |
|---|---|---|---|---|
| | EVA-3 | | PA-1 | |
| | | | | Extruder |
| | Extruder C | Extruder A | Extruder C | A |
| Zone 1 Rear | 275 | 275 | 485 | 485 |
| Zone 2 Center Rear | 365 | 365 | 485 | 485 |
| Zone 3 Center Front | 410 | 410 | 485 | 485 |
| Zone 4 Front | 455 | 455 | 485 | 485 |
| Flange | 455 | 455 | 485 | 485 |
| Pipe | 455 | 455 | 485 | 485 |
| Flange | 455 | 455 | 485 | 485 |
| Die | 455 | 455 | 485 | 485 |
| Die Lips | 455 | 455 | 485 | 485 |
| Melt Temperature | 450-455 | 450-455 | 495-500 | 495-500 |
| Chill Roll Temperature Top | 75 | 75 | 75 | 75 |
| Middle | 75 | 75 | 75 | 75 |
| Bottom | 75 | 75 | 75 | 75 |

For each material, 15.24-cm×15.24-cm (6 inch×6 inch) test sheets were prepared for acoustics testing. The values reported in Tables 2, 3, 4 and 5 are the average of three samples for each material. Table 2 summarizes structures with “stiff-soft-stiff” architecture.

TABLE 2

| | Nominal Thickness (mm) | | | Total | | Mass per unit |
|---|---|---|---|---|---|---|
| Composition | Layer 1 | Layer 2 | Layer 3 | thickness | Mass | area |
| Example | PA-1 | EVA-3 + Graft-2 (9:1) | PA-1 | (mm) | (g) | (g/cm²) |
| 1 | 0.25 | 2.0 | 0.25 | 2.59 | 61.6 | 0.265 |
| 2 | 0.5 | 1.5 | 0.5 | 2.47 | 59.9 | 0.258 |
| 3 | 0.64 | 1.3 | 0.64 | 2.57 | 63.3 | 0.273 |
| 4 | 0.76 | 1.0 | 0.76 | 2.53 | 63.1 | 0.272 |
| 5 | 1.0 | 0.5 | 1.0 | 2.43 | 62.3 | 0.268 |
| C6 | 2.5 | 0 | 0 | 2.54 | 65.8 | 0.283 |
| C7 | 0 | 2.5 | 0 | 2.50 | 56.3 | 0.242 |

Other structures were prepared using “soft-stiff-soft” architecture according to Table 3.

TABLE 3

| | | Layer 2 | | | Mass per unit |
|---|---|---|---|---|---|
| Composition | Layer 1 | PA-1 | Layer 3 | Mass | area |
| Example | EVA-3 + Graft-2 (9:1) | Nominal Thickness (mil) | EVA-3 + Graft-2 (9:1) | (g) | (g/cm²) |
| 8 | 0.76 | 1.0 | 0.76 | 58.3 | 0.251 |
| 9 | 0.89 | 0.635 | 0.889 | 60.3 | 0.259 |
| 10 | 1.0 | 0.50 | 1.0 | 59.4 | 0.255 |
| 11 | 1.15 | 0.25 | 1.15 | 56.7 | 0.244 |

Acoustic measurements were performed as described above and the results are summarized in Table 4 and 5. The expected insertion loss for each structure was calculated by using the monolayer film comprising EVA-3+Graft-2 (9:1) as the reference material. The acoustic benefit is the difference between the actual insertion loss and the expected insertion loss. Comparative Example C7, the monolayer film comprising EVA-3+Graft-2 (9:1) had the lowest Insertion Loss Factor for the band sum sound power level, but its low density provided insufficient sound reduction when the thickness of the samples was limited to practical limits. Surprisingly, the three-layer structures provided better than expected sound reduction, particularly when assessed at 1 kHz. They also had improved Insertion Loss Factor compared to the monolayer films.

Three-layer films prepared using “stiff-soft-stiff” architecture showed a significant benefit over monolayer films for the band sum and at 1 Hz. Three-layer films prepared using “soft-stiff-soft” architecture showed less benefit in sound reduction compared to the monolayer films for the band sum or at 1 kHz. These results indicate the surprisingly superior performance of the stiff-soft-stiff architecture for reducing sound while minimizing weight. The Insertion Loss Factor for the three-layer films was significantly better than that of dense filled compositions of the commercial standards.

TABLE 4

| | Band Sum (800 Hz to 20 kHz) | | | | | at 1 kHz | | | | |
|---|---|---|---|---|---|---|---|---|---|---|
| Composition | SPL | Insertion Loss (dBA) | | | Insertion Loss Factor | SPL | Insertion Loss (dBA) | | | Insertion Loss Factor |
| Example | (dBA) | measured | expected | Benefit | (g per dBA reduction) | (dBA) | measured | expected | Benefit | (g per dBA reduction) |
| 1 | 84.1 | 20.4 | 21.6 | −1.1 | 3.0 | 76.9 | 18.2 | 18.4 | −0.2 | 3.38 |
| 2 | 83.5 | 21.0 | 21.3 | −0.4 | 2.85 | 74.0 | 21.1 | 18.1 | 3.0 | 2.84 |
| 3 | 81.9 | 22.6 | 21.8 | 0.7 | 2.80 | 72.9 | 22.2 | 18.6 | 3.6 | 2.85 |
| 4 | 82.0 | 22.5 | 21.8 | 0.7 | 2.80 | 71.3 | 23.8 | 18.6 | 5.2 | 2.65 |
| 5 | 82.3 | 22.2 | 21.7 | 0.6 | 2.81 | 71.8 | 23.3 | 18.5 | 4.8 | 2.67 |
| C6 | 83.1 | 21.4 | 22.2 | −0.8 | 3.07 | 74.6 | 20.5 | 19.0 | 1.5 | 3.21 |
| C7 | 83.7 | 20.8 | 20.8 | 0 | 2.71 | 77.5 | 17.6 | 17.6 | 0 | 3.20 |
| No sample | 104.5 | | | | | 95.1 | | | | |

TABLE 5

| | Band Sum (800 Hz to 20 kHz) | | | | | | at 1 kHz | | | |
|---|---|---|---|---|---|---|---|---|---|---|
| Composition | SPL | Insertion Loss (dBA) | | | Insertion Loss Factor | SPL | Insertion Loss (dBA) | | | Insertion Loss Factor |
| Example | (dBA) | measured | expected | Benefit | (g per dBA) | (dBA) | measured | expected | Benefit | (g per dBA) |
| 19-7 | 84.4 | 20.1 | 21.1 | −1.0 | 2.90 | 77.9 | 17.2 | 17.9 | −0.7 | 3.39 |
| 19-8 | 83.8 | 20.7 | 21.4 | −0.7 | 2.91 | 77.2 | 17.9 | 18.2 | −0.3 | 3.37 |
| 19-9 | 83.8 | 20.7 | 21.3 | −0.6 | 2.87 | 77.1 | 18.0 | 18.1 | −0.1 | 3.30 |
| 19-10 | 84.3 | 20.2 | 20.9 | −0.7 | 2.81 | 76.2 | 18.9 | 17.7 | 1.3 | 3.0 |
| 23-6 | 83.1 | 21.4 | 22.2 | −0.8 | 3.07 | 74.6 | 20.5 | 19.0 | 1.5 | 3.21 |
| 23-7 | 83.7 | 20.8 | 20.8 | 0 | 2.71 | 77.5 | 17.6 | 17.6 | 0 | 3.20 |
| No sample | 104.5 | | | | | 95.1 | | | | |

### Examples 12-35

Additional Examples were prepared as part of a statistically designed factorial experiment including as variables the total thickness, interlayer adhesion (absence or presence of the graft copolymer), modulus of the soft polymer, hard polymer content, and the total thickness. The experiment was designed and data analyzed using Minitab® software.

The five-layer laminates in Table 6, Examples 12 to 27, had the general structure (in order) of nylon/tie/EVA/tie/nylon. The structures had total thickness of 1.5 to 2.6 mm, with nominal thickness for each nylon layer of 0.3 to 1.0 mm, nominal thickness for each EVA layer of 0.1 to 0.6 mm and tie layer thickness of 0.125 mm (100 mils=2.54 mm) The actual thickness was somewhat different than the nominal or targeted thickness. Two tie layer compositions were used, with GRAFT-1 providing stronger adhesion to nylon than EVA-1. Two different EVA's were used in the middle layer to assess how the softness of the EVA impacted sound deadening.

Additional laminates with “stiff layer-soft layer-stiff layer” architecture (layers A/B/C) without tie layers were prepared similarly by coextrusion. Examples 28-31 summarized in Table 7 were three-layer structures with the general structure (in order) of nylon/EVA/nylon.

Additional laminates with “soft layer-stiff layer-soft layer” architecture (layers A/B/C) were also prepared by coextrusion. Examples 32-35 summarized in Table 8 were three-layer structures with the general structure (in order) of EVA/nylon/EVA with nominal thickness for each nylon layer of 0.6 to 1 9 mm and nominal thickness for each EVA layer of 0.3 to 1.0 mm

Sound power level is reported as the band sum from 800 Hz to 20 kHz. Analysis showed the most important effects were nylon content of the stiff layer(s) and soft layer composition (softer is better) and total thickness (thicker is better). The soft-stiff-soft samples (Table 8) with a total thickness of about 2.5 mm but different thicknesses of the individual layers showed little difference in sound deadening performance Unlike filled polymer samples such as F-1 and F-2 comparative examples, there was no correlation between density and power level, which shows that the mechanism of sound deadening of the multilayer sheet is different from the filled polymer sheets.

TABLE 6

| | layer 1 | | layer 2 | | layer 3 | | layer 4 | | layer 5 | | Nominal | Sound |
|---|---|---|---|---|---|---|---|---|---|---|---|---|
| | | Nominal | | Nominal | | Nominal | | Nominal | | Nominal | total | Power |
| | | thickness | | thickness | | thickness | | thickness | | thickness | thickness | Level |
| Example | resin | (mm) | resin | (mm) | resin | (mm) | resin | (mm) | resin | (mm) | (mm) | (dBA) |
| 12 | PA-1 | 0.38 | GRAFT-1 | 0.125 | EVA-2 | 0.5 | GRAFT-1 | 0.125 | PA-1 | 0.38 | 1.5 | 91.6 |
| 13 | PA-1 | 0.64 | GRAFT-1 | 0.125 | EVA-2 | 1.0 | GRAFT-1 | 0.125 | PA-1 | 0.64 | 2.5 | 87.5 |
| 14 | PA-1 | 0.38 | EVA-1 | 0.125 | EVA-2 | 0.5 | EVA-1 | 0.125 | PA-1 | 0.38 | 1.5 | 88.4 |
| 15 | PA-1 | 0.57 | GRAFT-1 | 0.125 | EVA-2 | 0.125 | GRAFT-1 | 0.125 | PA-1 | 0.57 | 1.5 | 87.5 |
| 16 | PA-1 | 0.64 | GRAFT-1 | 0.125 | EVA-3 | 1.0 | GRAFT-1 | 0.125 | PA-1 | 0.64 | 2.5 | 88.8 |
| 17 | PA-1 | 0.64 | EVA-1 | 0.125 | EVA-2 | 1.0 | EVA-1 | 0.125 | PA-1 | 0.64 | 2.5 | 87.6 |
| 18 | PA-1 | 0.64 | EVA-1 | 0.125 | EVA-3 | 1.0 | EVA-1 | 0.125 | PA-1 | 0.64 | 2.5 | 88.2 |
| 19 | PA-1 | 0.38 | GRAFT-1 | 0.125 | EVA-3 | 0.5 | GRAFT-1 | 0.125 | PA-1 | 0.38 | 1.5 | 88 |
| 20 | PA-1 | 0.95 | EVA-1 | 0.125 | EVA-3 | 0.38 | EVA-1 | 0.125 | PA-1 | 0.95 | 2.5 | 83.8 |
| 21 | PA-1 | 0.95 | GRAFT-1 | 0.125 | EVA-2 | 0.38 | GRAFT-1 | 0.125 | PA-1 | 0.95 | 2.5 | 85.1 |
| 22 | PA-1 | 0.38 | EVA-1 | 0.125 | EVA-3 | 0.5 | EVA-1 | 0.125 | PA-1 | 0.38 | 1.5 | 83.9 |
| 23 | PA-1 | 0.95 | EVA-1 | 0.125 | EVA-2 | 0.38 | EVA-1 | 0.125 | PA-1 | 0.95 | 2.5 | 83.6 |
| 24 | PA-1 | 0.95 | GRAFT-1 | 0.125 | EVA-3 | 0.38 | GRAFT-1 | 0.125 | PA-1 | 0.95 | 2.5 | 84.5 |
| 25 | PA-1 | 0.57 | GRAFT-1 | 0.125 | EVA-3 | 0.127 | GRAFT-1 | 0.125 | PA-1 | 0.5 | 1.5 | 84.6 |
| 26 | PA-1 | 0.57 | EVA-1 | 0.125 | EVA-3 | 0.127 | EVA-1 | 0.125 | PA-1 | 0.57 | 1.5 | 84 |
| 27 | PA-1 | 0.57 | EVA-1 | 0.125 | EVA-2 | 0.127 | EVA-1 | 0.125 | PA-1 | 0.57 | 1.5 | 84.8 |

TABLE 7

| | Layer 1 (top layer) | | Layer 2 | | Layer 3 (bottom layer) | | Actual | Sound |
|---|---|---|---|---|---|---|---|---|
| | | Nominal | | Nominal | | Nominal | total | Power |
| | | thickness | | thickness | | thickness | thickness | Level |
| Example | resin | (mm) | resin | (mm) | resin | (mm) | (mm) | dBA |
| 28 | PA-1 | 1 | EVA-3 | 0.6 | PA-1 | 1 | 2.35 | 85.1 |
| 29 | PA-2 | 1 | EVA-3 | 0.6 | PA-2 | 1 | 2.33 | 84.4 |
| 30 | PA-2 | 1 | EVA-3 + Graft-2 (9:1) | 0.6 | PA-2 | 1 | 2.39 | 84.1 |
| 31 | PA-2 | 1 | EMA-1 + Graft-2 (9:1) | 0.6 | PA-2 | 1 | 2.38 | 84.2 |

TABLE 8

| | Layer 1 (top layer) | | Layer 2 | | Layer 3 (bottom layer | | | Sound Power |
|---|---|---|---|---|---|---|---|---|
| | | Nominal | | Nominal thickness | | Nominal thickness | Actual total | Level |
| Example | resin | thickness (mm) | resin | (mm) | resin | (mm) | thickness (mm) | dBA |
| 32 | EVA-3 + Graft-2 (9:1) | 0.3 | PA-1 | 1.9 | EVA-3 + Graft-2 (9:1) | 0.3 | 2.38 | 85.4 |
| 33 | EVA-3 | 0.3 | PA-1 | 1.9 | EVA-3 | 0.3 | 2.46 | 85.6 |
| 34 | EVA-3 | 1 | PA-1 | 0.6 | EVA-3 | 1 | 2.5 | 85.8 |
| 35 | EVA-3 | 0.6 | PA-1 | 1 | EVA-3 | 0.6 | 1.92 | 87.5 |

TABLE 9

| | Composition | MI (g/10 min) | M.P. (° C.) | H_{f} (J/g) |
|---|---|---|---|---|
| EAC-1 | E/22.5MAA/10iBA | 65 | 63 | 29.1 |
| EAC-2 | E/22.5MAA/10nBA | 65 | | |
| EAC-9 | E/21.5MAA/10nBA | | | |
| EAC-10 | E/22MAA/10iBA | | | 11.5 |
| EAC-11 | E/22MAA/10nBA | | | |

EAC-1, EAC-2, EAC-9, EAC-10 and EAC-11 are high acid terpolymers useful as soft layers in this invention. Ionomer compositions from EAC-1 and EAC-2 were prepared on a single screw or 30-mm twin screw extruder by treating the acid groups in the acid terpolymer base resin with metal cations and neutralizing to the indicated level to provide the Example compositions summarized in Table 2. The neutralizing agents were ZnO and/or zinc acetate for Zn ionomers, and Na₂CO₃ or NaOH for Na ionomers. For compounds containing mixed Zn and Na ions, the pure component ionomers were prepared first as described above, then the pure component ionomers were melt blended using a 30-mm twin screw extruder to generate the mixed Zn/Na ionomers. Table 10 shows the properties of the ionomers from base resins EAC-1 and EAC-2, which are also useful as soft layers in this invention.

TABLE 10

| | Base | | MI | M.P. | H_{f} |
|---|---|---|---|---|---|
| Example | Resin | % Neutralization | (g/10 min) | (° C.) | (J/g) |
| 1 | EAC-1 | 20% Zn | 6.0 | | |
| 2 | EAC-1 | 25% Zn | 2.3 | | |
| 3 | EAC-1 | 30% Zn | 1.3 | 48.7 | 43.3 |
| 4 | EAC-1 | 25% Na | 5.5 | 69.3 | 10.3 |
| 5 | EAC-2 | 26% Na | 6.2 | 70.1 | 12.1 |
| 6 | EAC-1 | 16.7% Zn/8.3% Na | 6.1 | | |
| 7 | EAC-1 | 12.5% Zn/12.5% Na | 5.4 | | |
| 8 | EAC-2 | 16.7% Zn/8.7% Na | 5.8 | | |
| 9 | EAC-2 | 12.5% Zn/13% Na | 6.0 | | |

What is claimed is:

1. A multilayer polymeric structure comprising a plurality of layers comprising
(a) at least one layer comprising a stiff polymeric material having a flexural modulus of 140 kpsi (965 MPa) to about 500 kpsi (3450 MPa); and
(b) at least one layer comprising a soft polymeric material having a flexural modulus of less than 75 kpsi;
wherein a layer of the stiff polymeric material alternates with a layer of the soft polymeric material; and the total thickness of the multilayer polymeric structure is from about 1.0 mm to about 14 mm.

2. The multilayer polymeric structure of claim 1, wherein each of the stiff polymeric materials independently has a modulus from about 140 kpsi to about 300 kpsi.

3. The multilayer polymeric structure of claim 1, wherein each of the stiff polymeric materials independently has a modulus from about 300 to about 500 kpsi.

4. The multilayer polymeric structure of claim 1, wherein the soft polymeric material has a modulus from about 1 kpsi to about 60 kpsi.

5. The multilayer polymeric structure of claim 1, wherein the soft polymeric material has a modulus from about 3 kpsi to about 30 kpsi.

6. The multilayer polymeric structure of claim 1, wherein the structure comprises one layer comprising the stiff polymeric material and one layer comprising the soft polymeric material; optionally further comprising an adhesive layer adjacent to the layer comprising the soft polymeric material.

7. The multilayer polymeric structure of claim 1 comprising at least three layers of polymeric materials such that two outer layers are on either side of an inner layer, wherein
(a) each of the two outer layers of polymeric materials independently comprises a stiff polymeric material having a flexural modulus of about 140 kpsi to about 500 kpsi; and a thickness of about 0.2 to about 1.8 mm;
(b) the inner layer of polymeric material comprises a soft polymeric material having a flexural modulus of less than 75 kpsi and a thickness of about 0.2 to about 2 mm; optionally further comprising an adhesive layer adjacent to one of the layers comprising the stiff polymeric material.

8. The multilayer polymeric structure of claim 7, wherein each of the two outer layers of polymeric materials independently has a modulus from about 300 kpsi to about 500 kpsi and the inner layer of polymeric material has a modulus from about 3 kpsi to about 30 kpsi.

9. The multilayer polymeric structure of claim 1, wherein each of the stiff polymeric materials independently comprises ABS, Acetal homopolymer, polyacrylic, acrylonitrile, polyetheretherketone, polyamide, polycarbonate, polybutylene terephthalate, polyethylene terephthalate, polyethylene terephthalate glycolate, polyimide, polypropylene, polystyrene, or polyurethane.

10. The multilayer polymeric structure of claim 9 wherein each stiff layer independently comprises a polyamide.

11. The multilayer polymeric structure of claim 1, wherein the soft polymeric material comprises polybutylene, low density polyethylene, ethylene copolymers with polar comonomers comprising copolymerized units of ethylene and a comonomer selected from a vinyl ester, an α,β-unsaturated monocarboxylic acid or its derivative, an α,β-unsaturated dicarboxylic acid or its derivative, an epoxide-containing monomer, or combinations of two or more thereof; wherein the polymer contains copolymerized units of 2 to 80 weight % of the comonomer, maleated polyethylene, maleated polypropylene, maleated styrene-ethylene-butene-styrene triblock copolymer, maleated ethylene vinyl acetate, maleated polybutadiene, or ethylene copolymers wherein ethylene is copolymerized with a functional comonomer selected from maleic anhydride; itaconic anhydride; maleic acid diesters; fumaric diesters; maleic acid monoesters, fumaric acid monoesters; or mixtures of any of these.

12. The multilayer polymeric structure of claim 11 wherein each stiff layer independently comprises a polyamide.

13. The multilayer polymeric structure of claim 11, wherein the soft polymeric material comprises the ethylene copolymer.

14. The multilayer polymeric structure of claim 13, wherein the ethylene copolymer comprises copolymerized units of ethylene and vinyl acetate or alkyl acrylate, or an ionomer of an ethylene acid copolymer comprising copolymerized units of ethylene, about 15 to about 30 weight % of copolymerized units of a C₃₋₈ α,β-ethylenically unsaturated carboxylic acid, and about 3 to about 13 weight % of copolymerized units of a softening comonomer selected from the group consisting of vinyl acetate, alkyl acrylate and alkyl methacrylate; wherein the acid moieties in the acid copolymer are nominally neutralized to a level from about 15% to about 30%.

15. The multilayer polymeric structure of claim 14, wherein the soft layer further comprises maleated polyethylene, maleated polypropylene, maleated styrene-ethylene-butene-styrene triblock copolymer, maleated ethylene vinyl acetate, maleated polybutadiene, or ethylene copolymers wherein ethylene is copolymerized with a functional comonomer selected from the group maleic anhydride; itaconic anhydride; maleic acid diesters; fumaric diesters; maleic acid monoesters and fumaric acid monoesters.

16. The multilayer polymeric structure of claim 1 further comprising at least one tie layer positioned between a stiff layer and a soft layer comprising maleated polyethylene, maleated polypropylene, maleated styrene-ethylene-butene-styrene triblock copolymer, maleated ethylene vinyl acetate, maleated polybutadiene, or ethylene copolymers wherein ethylene is copolymerized with a functional comonomer selected from the group maleic anhydride; itaconic anhydride; maleic acid diesters; fumaric diesters; maleic acid monoesters and fumaric acid monoesters; or mixtures of any of these.

17. The multilayer polymeric structure of claim 16 wherein at least one tie layer positioned between a stiff layer and a soft layer comprises maleated ethylene vinyl acetate or maleated polypropylene.

18. The multilayer polymeric structure of claim 1 comprising at least three layers of polymeric materials such that two outer layers are on either side of an inner layer, wherein
(a) each of the two outer layers of polymeric materials independently comprises a soft polymeric material having a flexural modulus of less than 75 kpsi and a thickness of about 0.3 to about 1.8 mm;
(b) the inner layer of polymeric material comprises a stiff polymeric material having a flexural modulus of about 140 kpsi to about 500 kpsi and a thickness of about 0.1 to about 1.9 mm.

19. The multilayer polymeric structure of claim 18 further comprising an adhesive layer adjacent to one of the layers comprising the soft polymeric material.

20. The multilayer polymeric structure of claim 18, wherein each of the two outer layers of polymeric material independently has a modulus from about 3 kpsi to about 30 kpsi and the inner layer has a modulus from about 300 kpsi to about 500 kpsi.

21. The multilayer polymeric structure of claim 20, wherein the stiff polymeric materials independently comprises ABS, Acetal homopolymer, polyacrylic, acrylonitrile, polyetheretherketone, polyamide, polycarbonate, polybutylene terephthalate, polyethylene terephthalate, polyethylene terephthalate glycolate, polyimide, polypropylene, polystyrene, or polyurethane.

22. The multilayer polymeric structure of claim 21 wherein the stiff layer comprises a polyamide.

23. The multilayer polymeric structure of claim 18, wherein the soft polymeric material comprises polybutylene, low density polyethylene, ethylene copolymers with polar comonomers comprising copolymerized units of ethylene and a comonomer selected from the group consisting of a vinyl ester, an α,β-unsaturated monocarboxylic acid or its derivative, an α,β-unsaturated dicarboxylic acid or its derivative, an epoxide-containing monomer, or combinations of two or more thereof; wherein the polymer contains copolymerized units of 2 to 80 weight % of the comonomer, maleated polyethylene, maleated polypropylene, maleated styrene-ethylene-butene-styrene triblock copolymer, maleated ethylene vinyl acetate, maleated polybutadiene, or ethylene copolymers wherein ethylene is copolymerized with a functional comonomer selected from the group maleic anhydride; itaconic anhydride; maleic acid diesters; fumaric diesters; maleic acid monoesters and fumaric acid monoesters; or mixtures of any of these.

24. The multilayer polymeric structure of claim 23, wherein the soft polymeric material comprises the ethylene copolymer.

25. The multilayer polymeric structure of claim 24, wherein the ethylene copolymer comprises copolymerized units of ethylene and vinyl acetate or alkyl acrylate, or an ionomer of an ethylene acid copolymer comprising copolymerized units of ethylene, about 15 to about 30 weight % of copolymerized units of a C₃₋₈ α,β-ethylenically unsaturated carboxylic acid, and about 3 to about 13 weight % of copolymerized units of a softening comonomer selected from the group consisting of vinyl acetate, alkyl acrylate and alkyl methacrylate; wherein the acid moieties in the acid copolymer are nominally neutralized to a level from about 15% to about 30%.

26. The multilayer polymeric structure of claim 18 further comprising at least one tie layer positioned between a stiff layer and a soft layer comprising maleated polyethylene, maleated polypropylene, maleated styrene-ethylene-butene-styrene triblock copolymer, maleated ethylene vinyl acetate, maleated polybutadiene, or ethylene copolymers wherein ethylene is copolymerized with a functional comonomer selected from the group maleic anhydride; itaconic anhydride; maleic acid diesters; fumaric diesters; maleic acid monoesters and fumaric acid monoesters; or mixtures of any of these.

27. The multilayer polymeric structure of claim 26 wherein at least one tie layer positioned between a stiff layer and a soft layer comprises maleated ethylene vinyl acetate or maleated polypropylene.

28. The multilayer polymeric structure of claim 1 combined with a substrate, selected from carpet, foam, fabric or scrim material, sheet or panel of polymeric material or composite with a flexural modulus greater than 500 kpsi, panel comprising metal, or panel comprising wood.

29. A method for providing sound deadening to a substrate comprising
1) preparing a multilayer structure according to claims 1; and
2) combining the multilayer structure with the substrate.

30. The method of claim 29 wherein the substrate comprises carpet, foam, fabric or scrim material, sheet or panel of polymeric material or composite with a flexural modulus greater than 500 kpsi, panel comprising metal, or panel comprising wood.
